(19) United States
(12) Patent Application Publication
(10) Pub. No.: US 2017/0225933 A1
(43) Pub. Date: Aug. 10, 2017

(54) METHOD FOR FILLING BOTTLES WITH WINE

(71) Applicant: DR TECH S.R.L, Minerbe (IT)

(72) Inventors: Livio DAL LAGO, Albaredo Adige (IT); Alberto RUGGIN, Bonavigo (IT)

(73) Assignee: DR TECH S.R.L, Minerbe (IT)

(21) Appl. No.: 15/506,004

(22) PCT Filed: Aug. 10, 2015
(86) PCT No.: PCT/IB2015/056076

§ 371 Date: Feb. 23, 2017

(30) Foreign Application Priority Data
Aug. 29, 2014 (IT) VR2014A000216

(51) Int. Cl. B67C 3/16; B67C 3/26

(52) U.S. Cl. CPC B67C 3/16; B67C 3/2634

(57) ABSTRACT

A method for filling a bottle (B) with wine (V) comprises in sequence the steps of injecting an inert gas (G)t into said bottle (B) to be filled allowing a subsequent outlet through the inlet mouth (I) of said bottle (B), hermetically closing said mouth (I) and putting under vacuum said bottle (B) through suction means connected to the distribution means (5,4); and performing the introduction in said bottle of said wine (V) until reaching a predetermined filling level through feeding means of said wine (V) connected to said distributor means (5,4); said injection steps of said inert gas (G) and introduction of the said wine (V) being realized through an inert gas flow (G) and respectively with the ascent of wine (V) towards said inlet mouth (I) from the bottom (F) of said bottle (B).

The present invention relates to a method for filling bottles with wine.

In particular, the subject invention is expected to be advantageously used in plants, both in-line and with reciprocating motion and in continuous rotation, suitable to perform the bottling of wine, to which the following description makes explicit reference without thereby losing its generality.

In general, in the field of bottling it has long been known the problems relating to the need of reducing as much as possible the absorption of oxygen by the wine during the filling stages in order to avoid oxidation, which would affect the quality of the bottled wine.

For this purpose, currently known bottling plant use a filling method which substantially comprises a preliminary step of injection of nitrogen within each bottle to be filled by means of a multi-cable injector nozzle disposed in the outlet mouth of the bottle partially inserted and arranged at the upper part of the neck of the bottle itself, and in order to allow for the subsequent escape of the air-nitrogen mixture thus obtained inside the bottle itself through the empty spaces left free from the nozzle on the open outlet mouth of the bottle.

Then the sealed closure of the bottle mouth is made through the application of a filling tap which contains the aforementioned coaxially sliding nitrogen injector nozzle, in order to create a vacuum inside the bottle and therefore at the beginning of the introduction of the wine flowing in particular along the inner peripheral surfaces of the bottle from the neck towards the bottom of the bottle itself.

Once reached the predetermined filling level, the filling cycle is stopped, the tap is moved away from the mouth, and the bottle is filled with the wine being progressively moved downwards such as to permit its subsequent sending to a final capping step, possibly preceded by a further injection of nitrogen at low pressure on the mouth of the bottle not yet capped.

Currently, this known method is however not able to completely eliminate oxidation phenomena of the wine, in particular along the inner peripheral surfaces of the bottle itself, due to residual oxygen and/or nitrogen gases left inside the bottle itself.

The aim of the present invention is to overcome the severe drawback mentioned above.

In particular, an aim of the present invention is to realize a bottling method permitting to significantly improve the quality and duration of the bottled wine.

The structural and functional characteristics of the present invention and their advantages over the known art will be clearer and more evident from the claims below, and in particular from an examination of the description that follows, referring to the attached drawings, showing the schematic of a preferred but non-limiting embodiment of a filling unit implementing the method in object, in which:

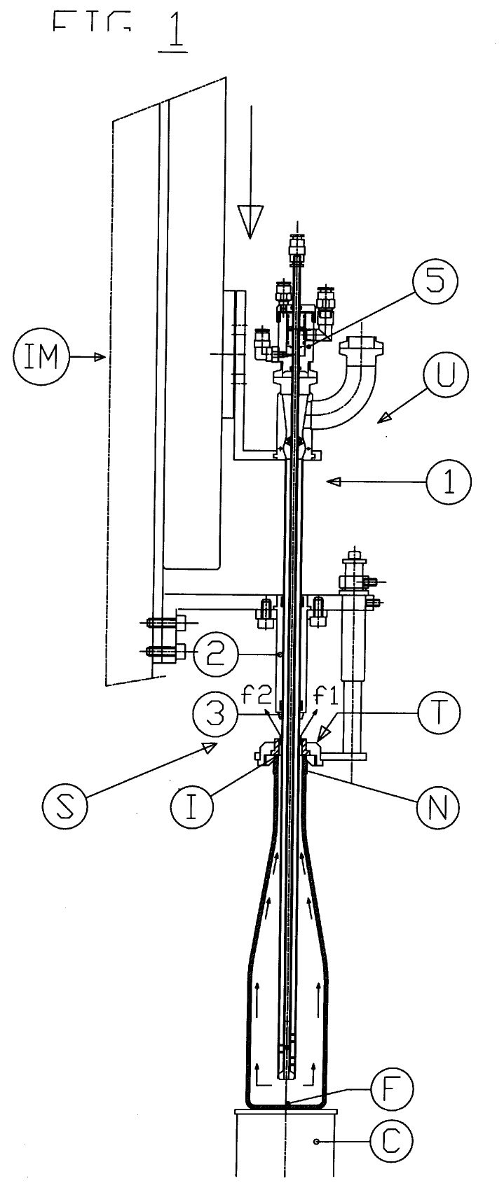

FIG. 1 is a schematic side view, partially in vertical section with parts removed for clarity, of a preferred embodiment of a filling unit in a first operating position;

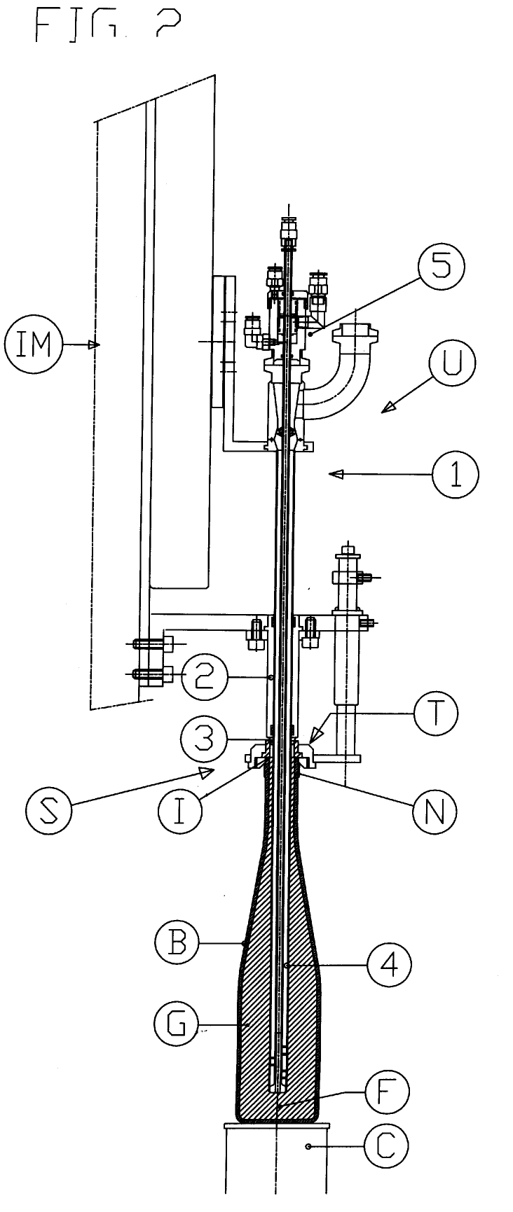

FIG. 2 shows the unit of FIG. 1 in a second operating position;

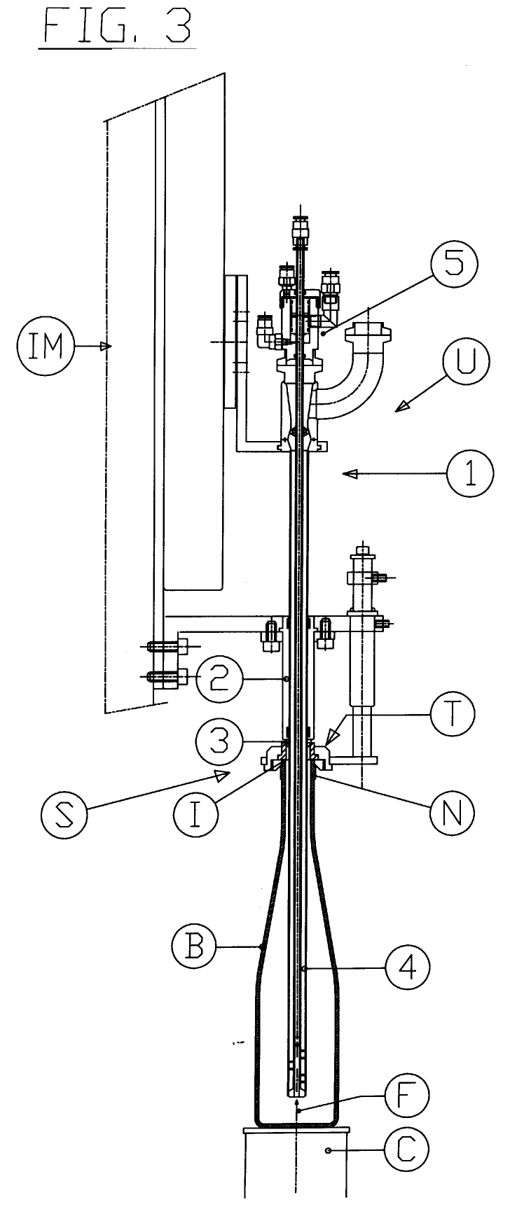

FIG. 3 shows the unit of FIG. 1 in a third operating position;

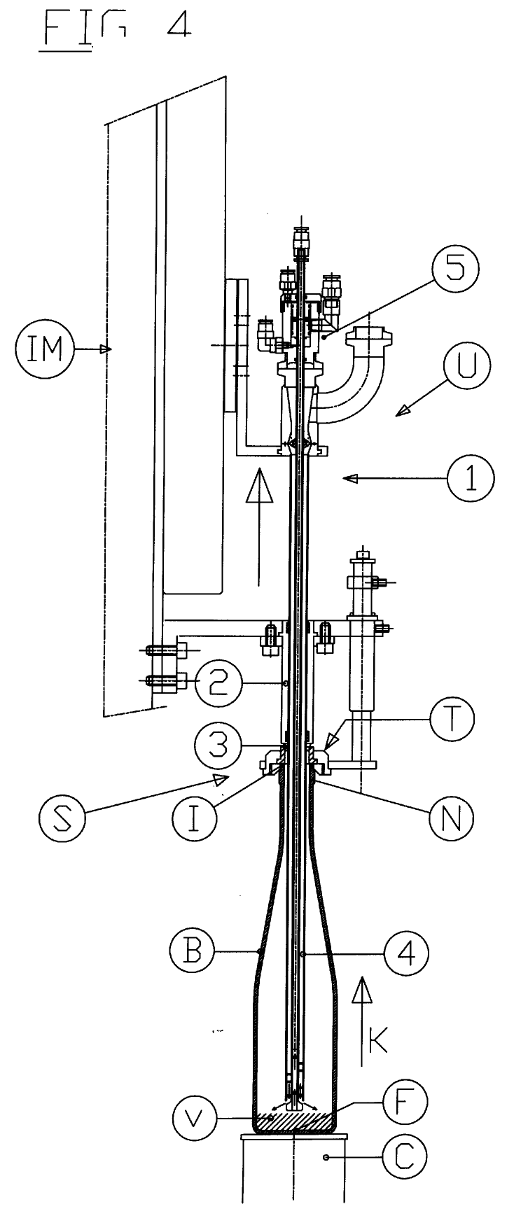

FIG. 4 shows the unit of FIG. 1 in a fourth operating position;

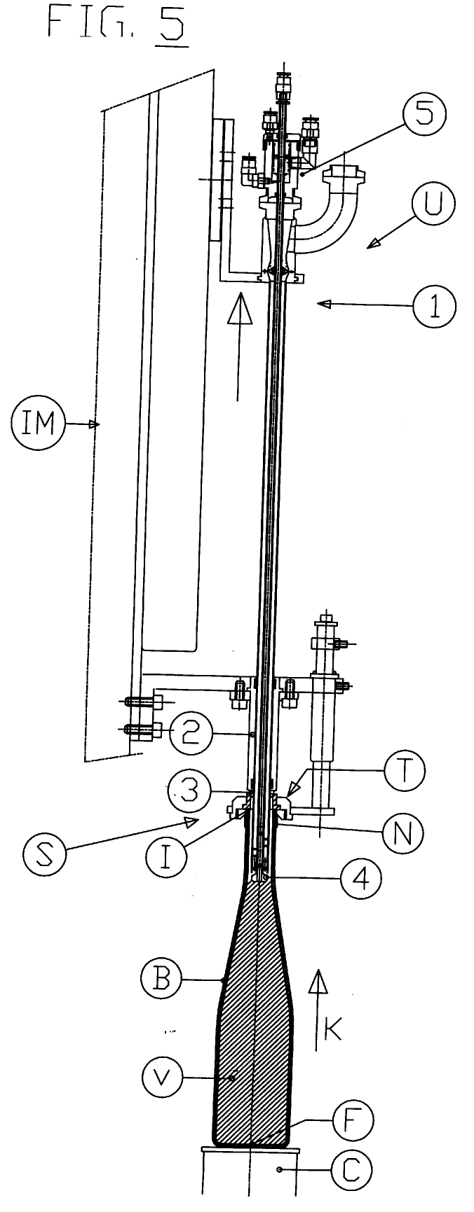

FIG. 5 shows the unit of FIG. 1 in a fifth operating position;

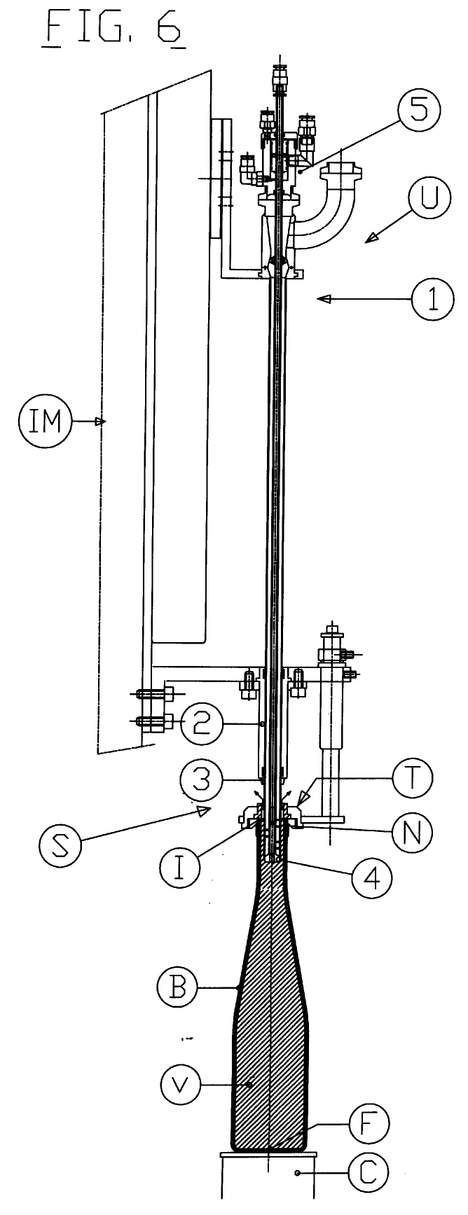

FIG. 6 shows the unit of FIG. 1 in a sixth operating position; and

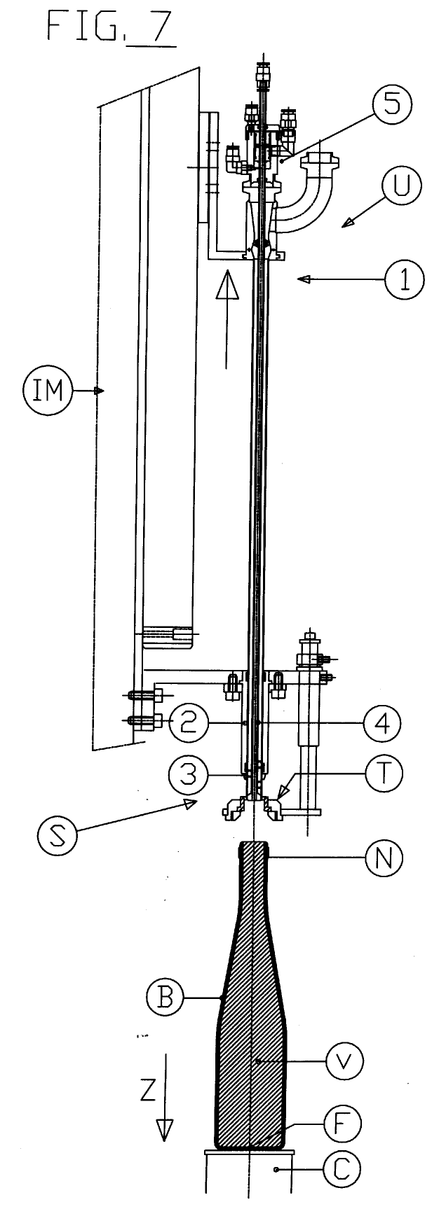

FIG. 7 shows the unit of FIG. 1 in a seventh and final operating position.

With reference to the attached FIGS. 1 to 7, globally indicated with U is a filling unit with wine V of containers, in particular of glass bottles B glass or similar, and being part of a wine bottling plant IM in itself generally known and substantially comprising at least one filling step S, at which the unit U is located, with C conveying means are indicated able to support and forward in sequence the bottles B beneath the filling unit U itself, and with T supporting and retaining mans of the neck N of each bottle B.

The unit U comprises a filling assembly 1 defined by a dispenser/distributing tap 5, a guide unit 2 an attaching portion 3 of which is able during use to be placed at and then brought in contact and closure with inlet mouth I of each bottle B on the outer upper portion of the neck N of the bottle B itself (FIGS. 2 to 5).

Coaxially inside the guide unit 2 a variably multi-cable cylindrical injector nozzle 4 is placed, provided for centrally and vertically sliding from and towards the inside and the bottom F of each bottle B through known handling means not illustrated.

The nozzle 4 of the tap is alternatively selectively connected through suitable known and not shown ducts and valve means, to a supply tank of the wine V, to an inert gas tank G (e.g. nitrogen), and finally to an air suction assembly.

In use, the unit U is able to perform the filling method of bottles B with wine V according to the following operating steps:
at the station S, each empty bottle B retained on the neck N by means T, is intercepted by the unit U, the nozzle 4 of which is slit on the guide unit 2 in order to be introduced substantially and completely into the bottle B, until reaching the inner bottom F of the bottle B itself (FIG. 1);
the inert gas G injection through the nozzle 4 is actuated within the bottle B in such a way that the inert gas G, flowing from the inner surface walls of the bottle B, is able to completely fill the bottle B (FIG. 2—dotted line) up to a subsequent optimal outlet push towards spaces or clearances left free by the nozzle 4 on the mouth I of the bottle B (FIG. 1—arrows f1 and f2); thus eliminating gaseous residues of oxygen inside the bottle itself;
the attachment portion 3 of the guide unit 2 is brought in contact and sealing closure of the inlet mouth I of each bottle B (FIG. 2), then the nozzle 4 is connected to the suction air source, in order to create a vacuum by completely removing the air inside the bottle B (FIG. 3);
an inlet step of the wine V inside the bottle B is actuated; the nozzle 4 introduced inside the bottle B is connected to the feeding tank of the wine V, which is then advantageously free to flow into the bottle B ascending towards the mouth I from the bottom F, to completely fill the bottle B itself until reaching the desired predefined final level, according to the simultaneous and progressive ascent of the nozzle 4 itself until reaching the neck N (FIGS. 4 and 5, arrow K);
the attachment portion 3 of the guide unit 2 is moved away from the inlet mouth I of the bottle B, also due to a relative progressive downward movement of the means C supporting the bottle B itself, and preferably but not limitedly, the inert gas G injection is again actuated through the nozzle 4 on the neck N of the bottle B itself (FIG. 6);
the bottle B so filled with wine V is further moved downwards (arrow Z in FIG. 7) so as to free it from the means T: the bottle B is then ready to be fed to a subsequent capping step, whereas the filling unit U is ready to receive a new empty bottle and start a new wine filling cycle.

Therefore, with the above described method actuated by the unit U, by mechanically limiting the exchange surfaces, it is avoided that the parts of residual oxygen inside the bottle are mixed with wine, limiting at the most oxidative effects and ensuring optimum quality and duration over time of the bottled wine.

1. A method for filling a bottle with wine comprising in succession the steps of: injecting inert gas inside said bottle to be filled permitting a subsequent escaping through input mouth of said bottle, hermetically closing said input mouth and putting said bottle into vacuum via suction means connected to distribution means; and filling said bottle with said wine until reaching a predetermined filling level by wine supply means connected to said distribution means; wherein said steps of injection said gas and filling wine are realized through a inert gas flow and, respectively, a wine flow going up 10 towards said input mouth from the bottom of said bottle.

2. The method according to claim 1, wherein said steps of injection of inert gas and fill said wine are realized by injectors means of said distribution means rendered sliding inside said bottle from and towards said bottom of said bottle.

3. The method according to claim 1, wherein the method comprises the further step of injecting inert gas at said input mouth of said bottle once said filling step of said wine is finished.

4. The method according to claim 1, wherein said steps of injection of inert gas and fill said wine are realized by injectors means of said distribution means rendered sliding inside said bottle from and towards said bottom of said bottle and wherein the method comprises the further step of injecting inert gas at said input mouth of said bottle once said filling step of said wine is finished.
